(19) United States
(12) Patent Application Publication
(10) Pub. No.: US 2012/0329027 A1
(43) Pub. Date: Dec. 27, 2012

(54) SYSTEMS AND METHODS FOR A LEARNER INTERACTION PROCESS

(76) Inventor: Bruce Lewolt, Newbury Park, CA (US)

(21) Appl. No.: 13/532,725

(22) Filed: Jun. 25, 2012

Related U.S. Application Data
(60) Provisional application No. 61/501,217, filed on Jun. 25, 2011.

(51) Int. Cl. G09B 3/00

(52) U.S. Cl. 434/322

(57) ABSTRACT

System and method for a learner interaction process comprising receiving information regarding one or more learners, receiving information regarding the educational material that the one or more learners would like to learn, presenting more than one question regarding the educational material prior to presenting the educational material to the one or more learners, receiving answers to the more than one questions presented to the one or more learners, presenting the educational material to the one or more learners, identifying the amount of time the one or more learns reviewed the educational material, presenting and receiving answers to more than one question regarding the educational material that the one or more learners has reviewed after the educational material has been presented to the one or more learners, and determining whether the one or more learners learned the educational material presented based on the one or more learners answers to the questions.

### RELATED APPLICATION

The present application is related to and claims priority to U.S. Provisional Patent Application No. 61/501,217 filed Jun. 25, 2011, the entire contents of which are incorporated herewith by reference.

### BACKGROUND OF THE INVENTION

1. Field of the Disclosure

The present disclosure generally relates to systems and methods for providing a unique learner interaction process for educational material to one or more learners. The present disclosure more specifically relates to systems and methods for combining educational material with personal learning system that enhances the learning process by improving the learning outcome and learning efficiency of one or more learners.

2. General Background

There are various types of educational materials that a learner can choose from. Often the educational material is one size fits all, meaning it is designed to be used by everyone and is not personalized for the particular learner and their style or method of learning or any other characteristic of that learner that can be leveraged to improve learning outcomes. Additionally, often times, it is difficult to impossible for the learner to determine which of the educational materials are better than others. It becomes difficult for the learner to analyze which educational material is the best for them and would enhance their knowledge to the fullest without having to read through different educational materials and spend excessive amount of time learning the material. Often times the learning material is stagnant and does not change based on either the particular learners needs or improving the content to be more effective for all of the learners. All of these factors decrease the efficiency and effectiveness of learning. Accordingly, there exists a need for a unique learner interaction process wherein the learner can input his requirements and based on the requirements by the learner the system creates educational material for that specific learner.

There also exists a need for a system that uses a method to learn and store a learning profile on each learner and uses this learning profile to make choices that enhance learning efficiency for each learner. There exists a need for a profile of information that can be used to enhance learning outcomes. A profile that is kept and enhanced over time.

There also exists a need to provide one or more learners with a learner interaction process for educational material wherein the educational material is tailored according to the needs and capabilities of one or more learners and the educational material improves and changes based on what material is most effective at teaching the one or more learners the concepts/topics in the shortest amount of study time or to a specific level of competence in the most efficient way. Based on the requirement and preferences of the one or more learners, the educational material is created and modified. There also exists a need to provide a unique learner interaction process which modifies the creating and presenting of the educational material based on the performance of the one or more learners. The use of such unique learner interaction process for educational material enhances the learning process of the one or more learners by improving the learning outcome and efficiency of the one or more learners. There also exists a need to provide the learner with tutoring or coaching assistance by a live person in a more efficient way then is available at the time of this disclosure. The present invention provides these and other benefits and advantages.

Educational programs are currently produced using one set of criteria that soon gets outdated. Students use these programs for short periods of time and then move on to newer more powerful educational programs. When they do the data about what they learned in the one system is lost. Accordingly there exists a need for a learning system that learners can use over a lifetime that accumulates information about the learner that can be used to continuously improve the learning effectiveness of learning for that learner.

Finally there exists a need for a system that can learn how to improve learning outcomes for groups of students who share specific characteristics and apply what has been learned to other learners who have those same set of characteristics. The present invention provides these and other benefits and advantages. Among other things, there exists a need for a method and system that works with any existing database of learning material. For example and not by way of limitation, a database of lessons, study questions, exercises, and teacher interaction items for 10 grade history or a college biology course. The system works with all common methods for identifying content, for example XML tagging or a student, teacher, content creator or other user can use the system to tag or designate the different components of educational materials.

### SUMMARY

In one embodiment of the present disclosure, a system and method for providing learners with educational material having a unique learner interaction process is provided.

In another embodiment of the present disclosure, a system and method for providing learners with educational material having unique learner interaction process is provided. In this method and system the educational material and personal learning system enhances the learning process by improving the learning outcome and learning efficiency of one or more learners.

In yet another embodiment since the system keeps a profile on many learners and tracks the social connections between learners the system can suggest the right connection for a learner to turn to for additional help regarding a topic the learner is struggling to understand. Further the system can facilitate the assistance by asking the friend to help and providing information and a tool the connection can use to provide the help.

In yet another embodiment of the present invention, the systems of methods of the present disclosure present a learner whose profile shows they are new to a particular subject or topic or that they have a hard time learning a particular subject or topic with background material to ramp up their knowledge prior to presenting the actual content in order to increase the odds that the learner will understand the actual material; choosing which format (text, video, virtual reality, audio) to present the material in and even choosing the pacing at which the material is presented (for example flashing text on the screen one phrase at a time and at pacing that accelerates reading speeds, enhances concentration and improves learning efficiency); presenting material both in the learners first language which is stored in the profile and the language that they are going to use the information which the inventor's research shows increases test scores by more than 20 percent; to deciding the difficulty level of the first set of study questions to present to the learner and then deciding how fast to increase the difficulty of the study questions on each topic and when the learner has reached mastery of a topic.

In yet another embodiment of the present disclosure, the system and method for unique learner interaction process for providing educational material is provided. The method and related system comprise: 1) receiving information regarding one or more learners from the one or more learners, 2) receiving information regarding the educational material that the one or more learners would like to learn 3) presenting more than one question regarding the educational material that the one or more learners would like to learn prior to presenting the educational material to the one or more learners, 4) receiving answers to the more than one questions presented to the one or more learners, 5) presenting the educational material to the one or more learners, 6) identifying the amount of time the one or more learns reviewed the educational material, 7) presenting more than one question regarding the educational material that the one or more learners has reviewed after the educational material has been presented to the one or more learners, 8) receiving answers to the more than one questions presented to the one or more learners after the educational material has been presented to the one or more learners, and 9) determining whether the one or more learners learned the educational material presented based on the one or more learners answers to the questions presented before and after the educational material was presented and the amount of time the one or more learners reviewed the educational material.

In one aspect of at least one embodiment of the present disclosure, the system and method for learner interaction process for educational material where the information received regarding one or more learners is from the group consisting of: name, age, native language, language level, motivation level, mental conditions, whether the one or more learners are listening to music, the format that the one or more learners prefer.

In another aspect of at least one embodiment of the present disclosure, a system and method for learner interaction process for educational material is provided where the information received regarding the educational material the one or more learner would like to learn is from the group consisting of: the subject matter of the educational material, the grade level, the format of the educational material, scores on exams taken by the one or more learners, the one or more learner's knowledge, and skill level.

In yet another aspect of at least one embodiment of the present disclosure is a system and method for a learner interaction process for educational material where the learning efficiency and effective of the learning material or learning method for one or more learners is determined by the difference in the performance of the learner before learning the educational material and the performance of the learner after learning the educational material divided by the total amount of time the learner spends learning the educational material.

In yet another aspect of at least one embodiment of the present disclosure, in the system and method for a learner interaction process for educational material the educational material is presented to the one or more learners based on the factors selected from the group consisting of: the learner's answers prior to learning the educational material, the learner's reading comprehension ability, the learner's working memory capacity, ideal spacing between study sessions.

In yet another aspect of at least one embodiment of the present disclosure, the system and method for learner interaction process for educational material also includes presenting the educational material to the one or more learners after identifying the portions of the educational materials that are most effective at teaching the content of the educational material and modifying the educational materials, or selecting between different versions of the educational material based on the performance of the one or more learners who learned the educational material.

In yet another aspect of at least one embodiment of the present disclosure, the system and method for learner interaction process further comprises creating a list of the educational material learned by the one or more learners and providing the one or more learners with access to all the educational material learned by the one or more learners.

In yet another embodiment of the present disclosure, the method and system for learner interaction process comprising 1) using an algorithm that determines the educational material provided to one more learners based on one of more factors regarding the one or more learners and factors that affect the learning outcomes of the one or more learners, 2) receiving information regarding the one or more learners and factors that affect the learning outcomes of the one or more learners, 3) selecting, modifying or creating educational material for the one or more learners using the algorithm based on the information received regarding the one or more learners and factors that affect the learning outcomes of the one more learners, 4) providing or providing access to the educational material selected, modified or created for the one or more learners to the one or more learners, and 5) determining the learning outcomes of the one or more learners for the educational material.

In yet another aspect of at least one embodiment of the present disclosure, the system and method for learner interaction process further comprises creating a digital profile of the one or more learners containing information about the one or more factors that affect learning outcomes of the one or more learners and applying the one or more factors that affect learning outcomes of the one or more learns to other learners or groups of learners based on the characteristics of the one or more learners or groups of more than one learner.

In yet another aspect of at least one embodiment of the present disclosure, the system and method for learner interaction process further comprises evaluating the effectiveness of modifying one or more factors regarding the one or learners and factors that affect the learning outcomes of the one more learners and applying the variables that result in the more effective learning outcome to the one or more learners.

In yet another aspect of at least one embodiment of the present disclosure, the system and method for learner interaction process, wherein the learner interaction method uses multiple sources of educational material for the one or more learners and determines which educational material is most effective with the one or more learners having the same or similar factors regarding the one or more learners.

In yet another aspect of at least one embodiment of the present disclosure, the system and method for learner interaction process further comprises suggesting educational material or groups of one or more learners for the one or more learners to join based on the similarity between the factors regarding the one or more learners and the factors of the one or more learners in the groups.

In yet another embodiment of the present disclosure, a system, and method for unique learner interaction process for providing educational material is provided. The method comprises 1) receiving information regarding one or more learners from the one or more learners, 2) receiving information regarding the educational material that the one or more learners would like to learn, 3) presenting more than one question regarding the educational material that the one or more learners would like to learn prior to presenting the educational material to the one or more learners, 4) receiving answers to the more than one questions presented to the one or more learners, 5) presenting the educational material to the one or more learners, 6) identifying the amount of time the one or more learns reviewed the educational material, 7) presenting more than one question regarding the educational material that the one or more learners has reviewed after the educational material has been presented to the one or more learners, 8) receiving answers to the more than one questions presented to the one or more learners after the educational material has been presented to the one or more learners, 9) determining whether the one or more learners learned the educational material presented based on the one or more learners answers to the questions presented before and after the educational material was presented and the amount of time the one or more learners reviewed the educational material, 10) creating a schedule for the one or more learners learning the educational material, and 11) prompting the one or more learners whenever the one or more learner is scheduled to learn the educational material.

In yet another aspect of at least one embodiment of the present disclosure, the system and method for learner interaction process further includes creating a list of pre-requisite knowledge that the learner should possess in order to understand the educational material, evaluating the learner to identify items on the list of pre-requisite knowledge that the learner does not know and creating pre-requisite educational material to teach the pre-requisite knowledge that the learner does not know.

In yet another aspect of at least one embodiment of the present disclosure, the systems, and methods include assessing the learner's knowledge of the pre-requisite educational material and determining which if any of the pre-requisite educational material to be presented to the learner and presenting the educational material to the learner on various types of devices.

In yet another aspect of at least one embodiment of the present disclosure, the systems and methods for learner interaction process for educational material include creating a list of topics learned by the learner along with connections to the educational material that the learner used to learn each topic and providing the learner with access to the list of topics learned and connection to the material used to learn each topic by the one or more learners.

In yet another embodiment of the present disclosure, the educational material is programmed with many different variables that can be changed to modify the learning experience to fit the needs of each learner and demands of each item of content in the system. Additional variables can also be added from time to time as needed.

In yet another aspect of at least one embodiment the present disclosure, the system and method for learner interaction process for educational material includes learning and study agents. The learning or study agent can be created by a non-programmer using a learning and study agent creation tool or can be entered at the program code level. A learning or study agent is a feature that can be varied by the learner, information stored about the learner or by the content that affects the learning outcome. For example each learner has different ideal setting for the number of days to skip between learning new material and studying that material and the number of days between the first and each subsequent time the learner studies the material. Presenting the learning material exactly on this schedule dramatically increases the learning efficiency and learning outcomes as measured by test scores.

In yet another embodiment the system and method of the present disclosure, the method uses information about the learner and provided by the learner to determine the starting settings for each learner. As the learner uses the system to learn and study, the system varies the settings and monitors the change in the relevant learning outcome. The main learning outcome is retained learning per hour of study (RLH). This is measured by the difference between a pre-test score (PRT) and post-test score (POT) divided by the total time the learner spends studying the material covered on the tests (TT), i.e. RLH=(POT−PRT)/TT. The system continues to modify the variables until the ideal setting is determined for the one or more learner.

In yet another aspect of at least one embodiment of the system and method, the method further includes a learning profile for one or more learners that store many different sets of ideal settings for each learning or study agent. This is needed because there are different influence items that affect the ideal setting. The system can store one or more influence item for each agent. An example of the influence item that affects the ideal spacing between study sessions is the subject matter of the content. Learners have a different ideal spacing for Math and English. If subject is entered into the influence item list the system will determine an ideal setting for each subject. Examples of influence item include but are not limited to: the learner's pre-test score, the learner's age, grade level, the subject matter of the content, the language level of the learner, the learners motivation to learn the material, the learner's designation by an educational institution like being below grade level or far below grade level or advanced, the learners conditions like attention deficit disorder, the learners intelligence, the learner's previous training on a subject, the learner's current knowledge of the subject, the learner's reading comprehension ability, the learner's working memory capacity etc. Once the settings for a learning or study agent are determined they are stored in the learner's learning profile. The system uses these settings with all future content. Thus when the learner uses one product in the system similar modifications are applied to other products of the system or other content that the learner chooses to learn.

In yet another aspect of at least one embodiment of the system and method, the method further includes identifying a group of learners who have a similar set of characteristics in their learning profile and then determining the settings for one or more learning agents that produce the best results in the greatest number of learners in this group. Then when a new learner enters the system with this same or a similar set of characteristics in their learning profile, the system can start by setting the one or more learning agents to the ideal settings for this group. Examples of identifying the ideal setting for a group include but are not limited to: Identifying students who share the characteristics of being second language learners and being designated by their school as being far below grade level in a subject and determining that the settings for the learning agents for how to present content for the best learning outcomes is to present learning material in both the student's native language and the language they will be tested on and further that the ideal setting for the learning agent that determines the number of days to skip between each study session on the topic is to use a progressive pattern that presents study material the next day after the lesson material has been presented and then two days later and three days after that and again four days later; identifying students who have low motivation levels and evaluating the ideal setting shared by the group for the learning agent that determines how often to send portions of the learners work to a teacher, Tutor or parent for evaluation and feedback and then using that setting for students who are new to the system who have the characteristic in their learning profile of have a low motivation to learn this subject; Identifying students who have a learning profile that includes being advanced in a subject and identifying that the learning agent that allows students to rate the effectiveness of lesson material for a specific topic shows that a specific item or group of items has the highest rating among this group of learners and then assigning that lesson material to other learners who have the profile that includes being an advanced in that subject.

In yet another embodiment of the present disclosure, the learner can access the components of the system through one or more computing device having internet or intranet or similar type of access. The computing device could be one or more type of computers including but not limited to desktop computers, laptop computers, netbook, server, terminal, iPad, tablets, immersive learning devices, virtual reality devices, text message devices, phones and smartphones and any future computing device. The methods of connecting the computing devices are well known in the art. Any known or future method could be used to practice the systems and methods of the present disclosure.

In yet another aspect of the present disclosure, the method includes providing asynchronous tutoring/mentoring by prompting the Tutor, coach, teacher, parent or mentor on exactly what learner created material to review and to suggest areas for comment or example comments or information that the tutor, coach, teacher, parent or mentor can use to assist them in commenting on the learner created material. For example in an essay or writing done by a learner prompting the tutor, coach, teacher, parent or mentor on what writing to comment on along with information the tutor, coach, teacher, parent or mentor can use to assist them in evaluating and commenting on that writing. The inventor has shown that this improved efficiency and focus on the highest value add items also increases the effectiveness of the learning and learning method so that it reaches levels that meet and in some cases exceed those found with live or one on one tutoring and coaching.

### DRAWINGS

The above-mentioned features and objects of the present disclosure will become more apparent with reference to the following description taken in conjunction with the accompanying drawings wherein:

FIG. 1 shows the block diagram of one embodiment of the learner interaction method and system for the educational materials used by one or more learners.

FIG. 2 shows the block diagram of one embodiment of the learner agent process.

FIG. 3 shows the block diagram of one embodiment of the learner scheduling process.

FIG. 4 shows the block diagram of one embodiment of the learner agent process for interacting with the one or more learners and the factors that affect the learning outcomes of the one more learners.

### DETAILED DESCRIPTION

The present disclosure is directed to a learner interaction system and method for educational materials used by one or more learners. The learner interaction system enhances the learning process of the learner by improving the learning outcome and learning efficiency.

In one embodiment, a learner interaction method for educational material is provided. The method comprises (1) receiving information regarding one or more learners from the one or more learners; (2) receiving information regarding the educational material that the one or more learners would like to learn; (3) presenting more than one question regarding the educational material that the one or more learners would like to learn prior to presenting the educational material to the one or more learners; (4) receiving answers to the more than one questions presented to the one or more learners; (5) presenting the educational material to the one or more learners; (6) identifying the amount of time the one or more learns reviewed the educational material; (7) presenting more than one question regarding the educational material that the one or more learners has reviewed after the educational material has been presented to the one or more learners; (8) receiving answers to the more than one questions presented to the one or more learners after the educational material has been presented to the one or more learners; and (9) determining whether the one or more learners learned the educational material presented based on the one or more learners answers to the questions presented before and after the educational material was presented and the amount of time the one or more learners reviewed the educational material.

In an aspect of at least one embodiment of the learner interaction method for the educational material, the one or more learner log into the system and provide their personal information which could be one or more factors including but not limited to the name, age, language level and the native language of the one or more learners.

In another aspect of at least one embodiment of the learner interaction method for the educational material, the one or more learners provide information regarding the educational material they wish to learn including but not limited to the subject matter of the educational material, the grade level, format of the educational material.

In yet another aspect of at least one embodiment of the learner interaction method for the educational material where the assessment of the educational material learned by the learner is determined by the difference in the performance of the learner before learning the educational material and the performance of the learner after learning the educational material divided by the total amount of time the learner spends learning the educational material.

In yet another aspect of at least one embodiment of the learner interaction method for educational material, the educational material is generated and presented to the one or more learner based on the factors including but not limited to the answers received by the one or more learner's prior to learning the educational material, the learner's reading comprehension ability, the learner's working memory capacity, ideal spacing between study sessions.

In yet another aspect of at least one embodiment of the learner interaction method for educational material, the educational material is presented to the one or more learners after identifying the portions of the educational materials that are most effective at teaching the content of the educational material and modifying the educational materials based on the performance of one or more learners who learned the educational material.

In yet another aspect of at least one embodiment of the learner interaction method for educational material, where a list of the one or more educational material learned by one or more learners is created and the one or more learners are provided access to all the educational material they have learned.

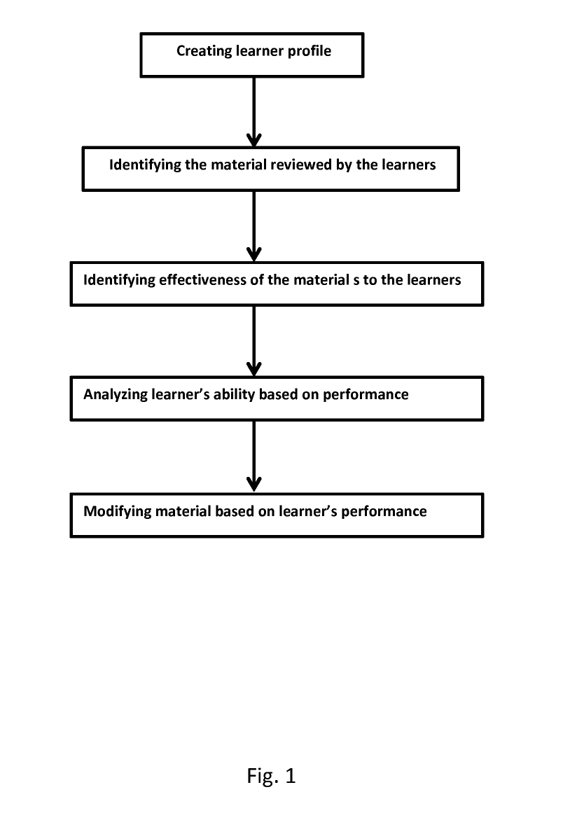

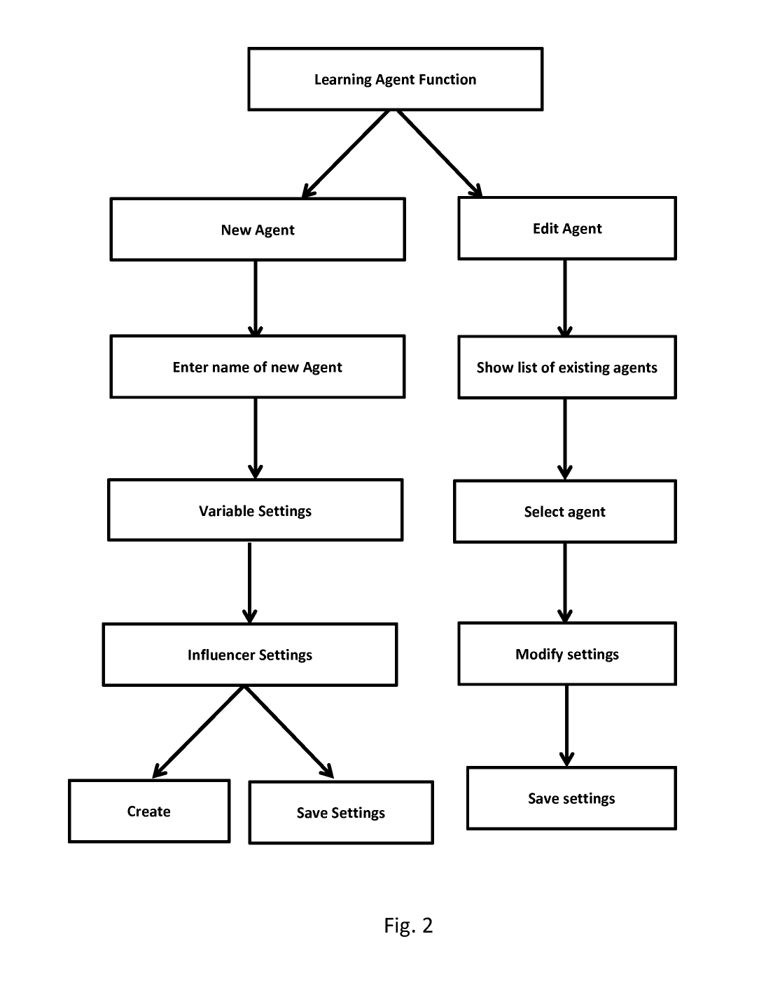

FIG. 1 Step 1: depicts the unique learner interaction method and system for the educational materials used by one or more learners comprising of various steps. First a learner profile is created for one or more learners. The learner profile identifies unique characteristics about individual learners that affect learning outcomes. These characteristics can be determined by the system or entered by a person. Examples of people who can enter information included but are not limited to: the student, a teacher, a parent, a tutor or a system or database that contains information on the learner. Examples of unique characteristics about individual learners that affect learning outcomes include but are not limited to: the learner's pre-test score, the learner's age, grade level, the subject matter of the content, the language level of the learner, the learners motivation to learn the material, the learner's designation by an educational institution like being below grade level or far below grade level or advanced, the learners conditions like attention deficit disorder, the learners intelligence, the learner's previous training on a subject, the learner's current knowledge of the subject, the learner's reading comprehension ability, the learner's working memory capacity, the number of times that a learner needs to restudy material in a specific subject in order to retain that material over a long period of time; the learners first or native language; gaps in the learner's knowledge of a specific subject; the learners reading ability; if listening to music improves learning outcomes when the learner is studying a specific subject, if learning performance is higher when the learner studies at a specific time of day or for specific lengths of time and then is prompted to take a short break, the best way to present content to a learner; the best format to use for presenting content; and any other item that can be used to improve learning outcomes. The learning profile can start with limited information however it gets more and more accurate as information from the learning agents in FIG. 2 is added to each learner's profile. In addition the learner's profile is saved so the improvements made to the learning profile in one learning interaction can be used to enhance the learning experience of subsequent learning interactions. The profile can also contain listings of the subjects one or more learners reviewed and references back to all the material one or more learner have reviewed related to those subjects.

When a new learner is enrolled in the system that learner's initial profile will not contain information for some of the characteristics that the learning agents shown in FIG. 2 need to use to improve learning outcomes. These gaps in the learning profile will be filled in by the system so that the learning agents have a starting point for improving learning outcomes. Examples of how the system can fill in the Gaps in the learning profile include but are not limited to; entering a pre-determined setting that is included in the settings for the learning agent; evaluating the information in the learners initial profile to identify specific characteristics that can be used to identify the student as being a member of a group of students who share this set of characteristics, for example second language learners who are far below grade level and using the settings that the learning agent has previously found to be the best for members of this group to fill in the gape in the learners learning profile.

The learning profile can also contain listings of relationships that one or more learners have to one another. For example who is in the same class as the student; who is connected to the learner by a social network and who the student knows. The learning profile can also contain listing of subject matter experts who are connected to the learner. Examples of subject matter experts include teachers, tutors, and parents. Still other items can include institutions that one or more learners are connected to that can provide learning assistance. For example the school the learner is attending; clubs like the Boy's or Girl's club where the learner is a member of the religious institution the learner is associated with. This information can be entered by one or more learners; subject matter experts or institution. In addition methods for importing this information from search engines can be used.

The system can use this database of relationships to suggest or connect one or more learners to the right person to provide assistance that enhances learning outcomes. For example when one or more students regularly get questions wrong or have to review lesson material multiple times or tell the system that they need additional assistance the system can identify the right person in the learner's profile who has expertise that can assist the student with the specific subject that the student is struggling with. In addition if outside experts have associated themselves with an association that the learner is associated with the system can use this information to suggest the right outside expert for the learner to ask for assistance. For example if a tutor has indicated that they are available to tutor students at a specific school or institution on a specific set of topics and one of those topics is the one that a student is struggling with the system can suggest the student contact or facilitate the contact with that person.

The system can use the information in the profile to identify which portions of the educational materials are effective at teaching the topics and concepts of the educational material. The system then analyzes the learner's ability based on the performance of the one or more learners learning the educational material. The system then modifies the educational material to include the content that was most effective and allowed one or more learners to achieve the highest performance with respect to learning the educational material.

FIG. 1 Step two: Identifying the material reviewed by the learners. In this step the system identifies the material to be used by learners. The system of identifying can be a common tagging method like XML tagging or by standards like Common Core Standards or by characteristics created in one or more learning agents shown in FIG. 2

FIG. 1 Step three: the system presents material to the learners and evaluates the effectiveness of the material for individual learners or groups of learners. The evaluation methods are determined by the learning agents in FIG. 2

FIG. 1. Step four: The system analyzes individual learners abilities based on their performance. This is done using learning agents in FIG. 2. The agents store the results of the analysis in the learners profile so the results can be used to enhance future learning outcomes

FIG. 1 Step Five: Information that the previous steps is used to modify items that affect learning in a way that improve the learning performance of each learner

As shown in FIG. 2 the unique learner interaction method and system for providing educational material has a Learning Agent Entry Function. In this function either a new learning agent is selected or an existing learning agent is edited. For a new learning agent the name of the new learning agent is entered and variable settings are selected and applied. The setting range for each selected variable is picked from the available variables list and other program modifiable characteristics are entered. The influencer settings are selected from a list of available influencers or by creating a new influencer, further a setting range for each influencer is selected. The influencer settings can be one or more items in the learner's profile and can also include items that are unique to the subject being presented including but not limited to learner's pre-test score, an evaluation of the student by someone else like a teacher, requests made by the learner and the device the learner is using to access the system. For example the age, grade level, language level of the learner, if the learner is learning in their native language, the learners reading comprehension ability, what prerequisite knowledge the learner has previously learned, the learner's working memory capacity, ideal spacing between study sessions from the learners profile can be combined with the subject matter of the content, and the students pre-test score to decide if basic prerequisite material should be presented to the learner prior to presenting the main content to be learned, how the content to be learned should be presented (for example shown in both the learners native language and the language that the learner will be tested in; presented as a video to watch or material to read; presented in short or long segments etc.).

After material has been presented students must study that material in an effective way on different days with nights of sleep in between in order to stimulate the brain to grow the connections that prevent forgetting and provide the student with the adaptive reasoning ability necessary to use the information on tests and in other tasks. One of the learning agents can use various methods for spacing the time intervals between when a learner is presented with study questions on a topic and when they are represented with study questions on the same topic a second time and the interval between the second time and the third and subsequent times. Each time a method is used information is saved in the learner's profile on how many times the set of questions had to be repeated before the student to achieve some specified goal like answering all the most difficult questions correctly. As each different strategy for the amount of time to wait between representing questions on a specific topic applied the results of that method are stored in the learner's profile. Finally after a pre-determined amount of different spacing options are applied and saved in the learner's profile the Learning Agent Function can evaluate the results stored in the learner's profile and select the option that produced the best results. In the future when the student studies more material in the same subject area (for example Math or English) the system will use the selected option to determine the spacing strategy to use for repeating the presenting of questions on a topic or for building a study schedule for the learner.

Another example of a Learning Agent Function information that is stored for only a few days or weeks and relates only to a specific set of content. For example when quizzing a learner on a specific set of topics from lessons presented to the learner the system can track the and save information about the difficulty level of the questions a student was able to answer correctly vs the difficulty of the questions that were answered incorrectly in one study session and store that information until the next time the learner is asked to answer questions on these topics. The historical information can be used to increase the difficulty of questions regarding topic where the learner answered questions correctly in the last quizzing session and keep the same or decrease the difficulty of the questions that are presented for subjects where the learner missed the questions on the previous study session. At the end of this session or a set of sessions of presenting questions the previous information is erased and the current information about which questions the learner answered correctly or incorrectly is saved and used for the next time the learner is presented with questions on these subjects. In this way the system can use the information temporarily stored in the learning profile along with the Learning Agent function to enhance learning outcomes.

Further by opting for the save setting the person or persons using the system can save the selected setting but does not build or apply the agent whereas the create option builds and applies the new learning agent. For editing an existing learning agent the learner selects a learning agent from the list of existing agents and the system opens a settings window that the learner can use to modify and save the settings.

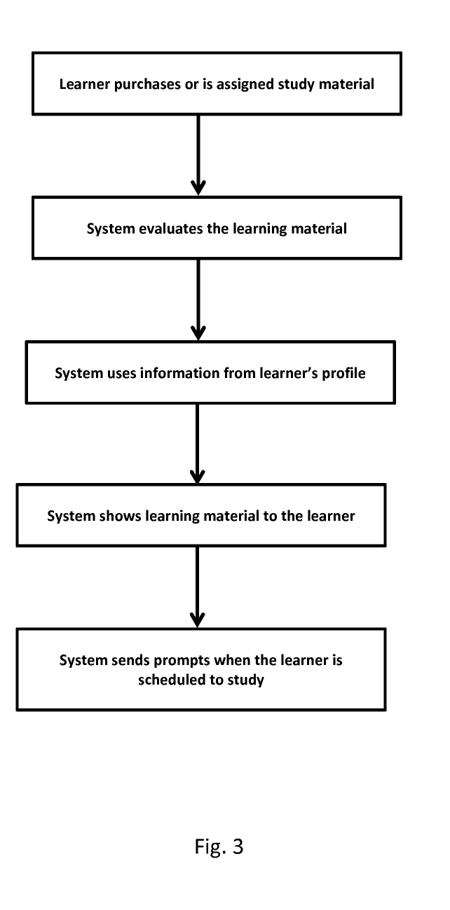

As shown in FIG. 3, the unique learner interaction system and method for providing educational material has a Study Schedule Function. In this function the content for the study schedule of an individual learner is generated. First the learner purchases or is assigned a learning material. Then the system evaluates the length of the material to be studied and the other learner entered data like length of the time the learner has to learn the material and the dates the learner wishes to take tests on the material. Based on the information in the learner's learning and study profile the system creates a schedule for the learners. The learner's study schedule includes but is not limited to the dates the learners should study, what should be studied on each date. The system shows the learning and study schedule to the learner and sends prompts to the learner on days when the learner is scheduled to study. The learner can be prompted by various means including but not limited to email, text message. The system can also push study information to the learner automatically at the designated study times. For example if the schedule calls for the learner to answer a set of study questions on a specific morning the system can send text messages with the questions to the learners phone. If the learner needs to learn something new the learner can send an alert message to the learner and then present the learner with different options for receiving the lesson. For example if the learner is exercising and has a earphones the learner may select to have the lesson read to them while they exercise.

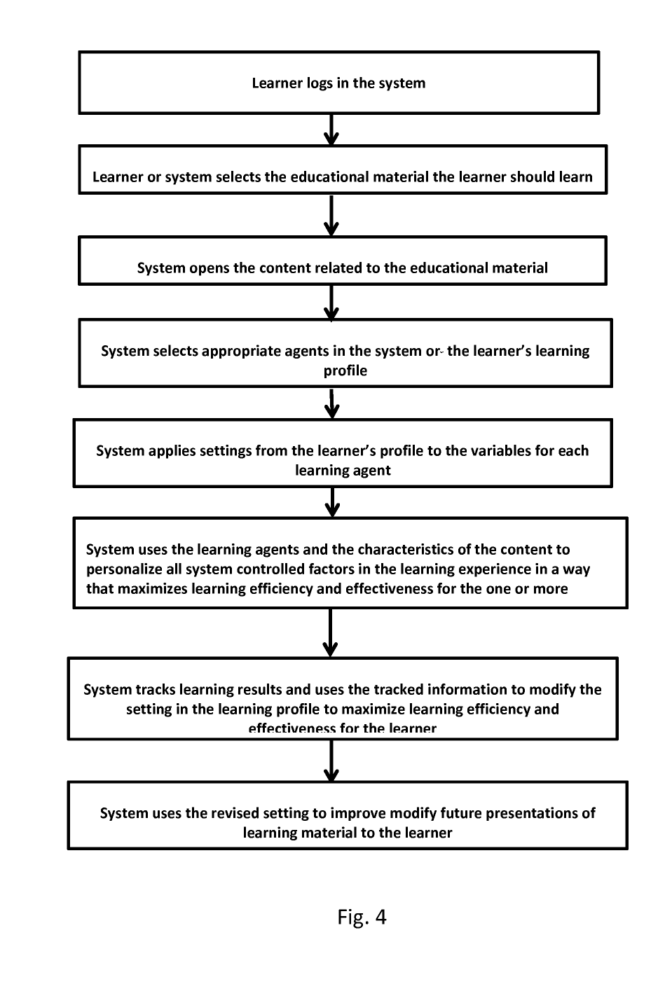

FIG. 4 depicts the unique learner interaction method and system for educational materials used by one or more learners comprising of various steps. First one or more learners log into the system. Then the learner or the system selects the content each individual learner should learn or study at that time. For example if the content is selected by the system then the system can use information in the learners profile and or information related to the content and the course of study to select the content. Next the system opens the materials related to that content into a temporary storage area in the system so the learning agents can use the material. Next the system selects the appropriate learning agents that are referenced in the learner's learning profile or agents stored in the system. These agents could be related to the overall topic of the subject to be studied or to the specific lesson. They could also be related to items that are applied to the type of learning experience or the device being used by the learner. One example of an agent that could be applied to the overall topic is an agent for playing music or sounds that cause the brain to enter a state that corresponds to a setting in the learner profile related to that subject. For example music or combinations of sounds and spacing that causes the brain to enter a state where it produces more beta and theta waves because the learner's profile shows that learning of this subject is enhanced when the brain of the learner is in this state. An example of content specific agents is when the system selects study questions because the learners schedule calls for the learner to be presented with study questions on this day then the system will select the learning agents related to the presenting of questions. After the appropriate agents are opened the system uses information on the characteristics of the content to be presented along with settings for the selected learning agents to personalize all system controlled factors in the learning experience in a way that maximizes learning efficiency and effectiveness for each learner. For example selecting, modifying and presenting one or more sections of the content and the order, pacing and other learning agent controlled factors related to the presentation of the content. After the presentation of one or more learning materials the system can use the new information about results achieved by one or more learners to modify the settings in one or more learner's profiles so that the learning efficiency and effectiveness of the next learning experiences are improved.

In one embodiment the present disclosure, the system and method for learner interaction process for educational material include learning and study agents. The learning or study agent can be created using the learning agent creation tool or can be entered at the program code level. A learning or study agent is a function that controls one or more factors of the learner's learning experience where that function contains variables. Further, the factors applied to those variables for a specific instance where that agent is applied are pulled from the learners profile and or from factors related to the content. The result is that the learning experience affected by the learning agent is personalized in a way that benefits each individual learner. For example each learner has different ideal setting for the number of days to skip between learning new material and studying that material and the number of days between the first and each subsequent time the learner studies the material. Presenting the learning material exactly on this schedule dramatically increases the learning efficiency and learning outcomes as measured by test scores.

In another embodiment of the present disclosure, the systems and methods determine the efficiency of the learning process and not only how well something has been learned. In on aspect of at least one embodiment, the efficiency of the learner interaction process is determined by the difference between the pre-test score and post-test score on two different variable settings for the same learner but yielding substantially different results. For example if the pre-test score and the post-test score of a particular learner is 20 points, but the total time that the educational material was reviewed by the learner for one variable setting was 2 hours and the total time that the educational material was reviewed by the learner for the second variable setting was 1 hour then the learning efficiency of the second method would be two times that of the first.

In yet another embodiment of the present disclosure, the system and method for learner interaction process for educational material is determining the effectiveness of the learner interaction process to the one or more learners by the educational material based on or derived from the one or more learners' answers to the questions presented before and after the educational material was presented divided by the amount of time in which the one or more learners reviewed the educational material.

In yet another embodiment of the present disclosure, the system and method for learner interaction process for educational material uses information about the one or more learner and provided by the one or more learner to determine the starting settings for each learner. As the learner uses the system to learn and study, the system varies the settings and monitors the change in the relevant learning outcome. The main learning outcome is retained learning per hour of study (RLH). This is measured by the difference between a pre-test score (PRT) and post-test score (POT) divided by the total time the learner spends studying the material covered on the tests (TT), i.e. RLH=(POT−PRT)/TT. The system continues to modify the variables until the ideal setting is determined for that learner.

In one aspect of at least one embodiment the system and method for learner interaction process for educational material includes a learning profile for one or more learners that stores many different sets of ideal settings for each learning or study agent. This is needed because there are different influence items that affect the ideal setting. The system can store one or more influence item for each agent. An example of the influence item that affects the ideal spacing between study sessions is the subject matter of the content. Learners have a different ideal spacing for Math and English. If subject is entered into the influence item list the system will determine an ideal setting for each subject. Examples of influence item include but are not limited to: the learner's pre-test score, the learner's age, grade level, the subject matter of the content, the language level of the learner, the learner's reading comprehension ability, the learner's working memory capacity etc. Once the settings for a learning or study agent are determined they are stored in the learner's learning profile. The system uses these settings with all future content. Thus when the learner uses one product in the system similar modifications are applied to other products of the system.

In yet another embodiment of the present disclosure, the learner can access the components of the system through one or more computing device having internet access. The computing device could be one or more type of computers including but not limited to desktop, laptop, netbook, terminal or device with a processor including but not limited to iPad, tablets, and smartphones.

One of the many benefits and advantages of the present invention includes providing the ability to select the right difficulty level of the education material or questions and then increase the difficulty on an individual basis until the learner can easily understand the more difficult material or answer the more difficult questions on two or more different days. It is believed that long term recall is increased by 300% and long term adaptive reasoning skills are produced by doing so. On the other hand with one set of one size fits all educational material and questions often the questions are either too hard or too easy for a specific learner and they don't progress in difficulty as the learner can handle the increase. Therefore the learner experiences rapid forgetting and poor adaptive reasoning ability. This is bad for the learner and bad for the society who is paying to educate the learner in hopes that the learner will reach their full productive capacity as an adult. Learners often turn to their friends or social network for help when they are struggling to learn something. The problem is that they have no way of knowing who would really be the best person or connection to turn to for help. The system solves this problem because it has learning profiles on all the connections that the learner is connected to and can use these profiles to suggest the right person (connection) or group of persons (connections) to turn to. The system uses information in the learner's profile along with system programming to suggest the right person for the student to contact for help which eliminates this problem.

An important part of this invention is that new learning agents can be created at any time and those learning agents can leverage historical information stored in the learners profile to improve future learning outcomes. In addition existing learning agents can be improved. For example global information about the effectiveness of learning agents across many students or groups of students who have similar information in their learning profile can be analyzed and used to improve the learning agents or point to the need for additional learning agents. For example information about the effect of a specific Learning Agent on a large group of high school second language learners can be evaluated in order to discover ways to further improve learning outcomes for high school second language learners. Additionally, it at least one embodiment of the present disclosure, when new learners join the system who share the characteristics of a group the most common settings can that were determined for that group are used for the initial settings for the new learner.

While the systems and methods have been described in terms of what are presently considered to be the most practical and preferred embodiments, it is to be understood that the disclosure need not be limited to the disclosed embodiments It is intended to cover various modifications and similar arrangements included within the spirit and scope of the claims, the scope of which should be accorded the broadest interpretation so as to encompass all such modifications and similar structures. The present disclosure includes any and all embodiments of the following claims.

What is claimed is:

1. A learner interaction method for educational material, the method comprising:
receiving information regarding one or more learners from the one or more learners;
receiving information regarding the educational material identified by the one or more learners;
presenting more than one question regarding the educational material identified by the one or more learners prior to presenting the educational material to the one or more learners;
receiving answers to the more than one questions presented to the one or more learners;
presenting the educational material to the one or more learners;
identifying the amount of time the one or more learns reviewed the educational material;
presenting more than one question regarding the educational material that the one or more learners have reviewed after the educational material has been presented to the one or more learners;
receiving answers to the more than one questions presented to the one or more learners after the educational material has been presented to the one or more learners; and
determining whether the one or more learners learned the educational material presented based on the one or more learners' answers to the questions presented before and after the educational material was presented and the amount of time the one or more learners reviewed the educational material.

2. The method of claim 1, wherein the information received regarding one or more learners is from the group consisting of: name, age, native language, language level, motivation level, mental conditions, whether the one or more learners are listening to music, the format that the one or more learners prefer.

3. The method of claim 1, wherein the information received is information regarding the educational material is information from the group consisting of: the subject matter of the educational material, the grade level, the format of the educational material, scores on exams taken by the one or more learners, the one or more learner's knowledge, and skill level.

4. The method of claim 1, wherein the educational material learned by the learner is determined by the difference in the performance of the learner before learning the educational material and the performance of the learner after learning the educational material divided by the total amount of time the learner spends learning the educational material.

5. The method of claim 1, wherein the educational material is presented to the one or more learners based on the factors selected from the group consisting of: the answers received by the one or more learner's prior to learning the educational material, the learner's reading comprehension ability, the learner's working memory capacity, ideal spacing between study sessions.

6. The method of claim 1, further presenting the educational material to the one or more learners after identifying the portions of the educational materials that are most effective at teaching the content of the educational material and modifying the educational materials based on the performance of one or more learners who learned the educational material.

7. The method of claim 1, further comprising creating a list of the educational material learned by the one or more learners and providing the one or more learners with access to the one or more educational material learned by the one or more learners.

8. A learner interaction method for educational material, the method comprising:
receiving information regarding one or more learners from the one or more learners;
receiving information regarding the educational material identified by the one or more learners;
presenting more than one question regarding the educational material identified by the one or more learners learn prior to presenting the educational material to the one or more learners;
receiving answers to the more than one questions presented to the one or more learners;
presenting the educational material to the one or more learners;
identifying the amount of time the one or more learns reviewed the educational material;
presenting more than one question regarding the educational material that the one or more learners have reviewed after the educational material has been presented to the one or more learners;
receiving answers to the more than one questions presented to the one or more learners after the educational material has been presented to the one or more learners;
determining whether the one or more learners learned the educational material presented based on the one or more learners answers to the questions presented before and after the educational material was presented and the amount of time the one or more learners reviewed the educational material;
creating a schedule for the one or more learners learning the educational material; and
prompting the one or more learners whenever the one or more learner is scheduled to learn the educational material.

9. The method of claim 8, wherein the one or more learners are prompted to learn the educational material by email or text message.

10. The method of claim 8, wherein the information received regarding one or more learners is from the group consisting of: name, age, native language, language level, motivation level, mental conditions, whether the one or more learners are listening to music, the format that the one or more learners prefer.

11. The method of claim 8, wherein the information received regarding the educational material identified by the one or more learner from the group consisting of: the subject matter of the educational material, the grade level, the format of the educational material, scores on exams taken by the one or more learners, the one or more learner's knowledge, and skill level.

12. The method of claim 8, wherein the educational material learned by the learner is determined by the difference in the performance of the learner before learning the educational material and the performance of the learner after learning the educational material divided by the total amount of time the learner spends learning the educational material.

13. The method of claim 8, wherein the educational material is presented to the one or more learners based on the factors selected from the group consisting of: the answers received by the one or more learner's prior to learning the educational material, the learner's reading comprehension ability, the learner's working memory capacity, ideal spacing between study sessions.

14. The method of claim 8, further presenting the educational material to the one or more learners after identifying the portions of the educational materials that are most effective at teaching the content of the educational material and modifying the educational materials based on the performance of one or more learners who learned the educational material.

15. The method of claim 8, further comprising creating a list of the educational material learned by the one or more learners and providing the one or more learners with access to the one or more educational material learned by the one or more learners.

16. A learner interaction method for educational material, the method comprising:
using an algorithm that determines the educational material provided to one more learners based on one of more factors regarding the one or learners and factors that affect the learning outcomes of the one more learners;
receiving information regarding the one or more learners and factors that affect the learning outcomes of the one more learners;
modifying or creating educational material for the one or more learners using the algorithm based on the information received regarding the one or more learners and factors that affect the learning outcomes of the one more learners;
providing or providing access to the educational material modified or created for the one or more learners to the one or more learners; and
determining the learning outcomes of the one or more learners for the educational material.

17. The method of claim 16, further comprising creating a digital profile of the one or more learners containing information about the one or more factors that affect learning outcomes of the one or more learners and applying the one or more factors that affect learning outcomes of the one or more learners to other learners or groups of learners based on the characteristics of the one or more learners or groups of more than one learner.

18. The method of claim 16, further comprising evaluating the effectiveness of modifying one or more factors regarding the one or learners and factors that affect the learning outcomes of the one more learners and applying the variables that result in the more effective learning outcome to the one or more learners.

19. The method of claim 16, wherein the learner interaction method uses multiple sources of educational material for the one or more learners and determines which educational material is most effective with the one or more learners having the same or similar factors regarding the one or more learners.

20. The method of claim 17, further comprising suggesting educational material or groups of one or more learners for the one or more learners to join based on the similarity between the factors regarding the one or more learners and the factors of the one or more learners in the groups.
